(19) United States
(12) Patent Application Publication
(10) Pub. No.: US 2006/0112286 A1
(43) Pub. Date: May 25, 2006

(54) Method for dynamically reprovisioning applications and other server resources in a computer center in response to power and heat dissipation requirements

(76) Inventors: Ian Nicholas Whalley, Pawling, NY (US); Steve R. White, New York, NY (US)

Correspondence Address: Whitham, Curtis, & Christofferson, P.C., Suite 340, 11491 Sunset Hills Road, Reston, VA, 20190, US

(21) Appl. No.: 10/994,417

(22) Filed: Nov. 23, 2004

(51) Int. Cl. G06F 1/26

(52) U.S. Cl. 713/300

(57) ABSTRACT

Applications and other server resources in a computer center are dynamically reprovisioned in response to power consumption and heat dissipation loads. Power consumption and temperature of each of a plurality of data center components which comprise the computer center are monitored. Based on the monitored power consumption and temperature, one or more applications from one or more data center components are relocated to other data center components of the computer center as needed to change power consumption and heat dissipation loads within the computer center. Also, based on the monitored power consumption and temperature, one or more applications running on one or more data center components of the computer center may be rescheduled as needed to change power consumption and heat dissipation loads within the computer center. Cooling devices within the computer center may also be controlled as needed to change heat dissipation loads within the computer center.

### BACKGROUND OF THE INVENTION

1. Field of the Invention

The present invention generally relates to monitoring and controlling cooling and power consumption loads of a computer center and, more particularly, to using techniques from the fields of autonomic and on demand computing in order to permit a computer center to be dynamically reprovisioned in order to satisfy ever changing heat dissipation and power consumption environments.

2. Background Description

As time progresses, the need for more computing power has exceeded the increase in speed of computers. Consequently, not only are new computers purchased to replace older, slower computers, but more and more computers are required in order to keep up with the ever increasing expectations and demands of corporations and end-users.

This has resulted in computers becoming smaller and smaller. Modern servers are specified in terms of rack spacing or “Units (U)”, where 1U is 1.75″ high in a standard 19″ wide rack. Thus, a 2U computer is 3.75″ high, and so on. 1U servers have become extremely common, and are often the choice in corporate server rooms.

However, self-contained computers, even when only 1.75″ high (i.e., 1U) are still too large for many applications. So-called “blade” server systems are able to pack computing power even more densely by offloading certain pieces of hardware (e.g., power supply, cooling, CD (compact disc) drive, keyboard/monitor connections, etc.) to a shared resource, in which the blades reside. For example, once such blade system is the IBM “BladeCenter”. The BladeCenter chassis can hold 14 blades (each of which is an independent computer, sharing power and auxiliary resources with the other blades in the BladeCenter) and is a 7U unit (that is to say, it is 12.25″ in height in a standard rack configuration). This is half the size of 14 1U machines, allowing approximately twice as much computing power in the same space.

Cooling, which was alluded to above, is one of the significant problems facing computer centers. Current technology paths mean that as central processing units (CPUs) get faster, they contain more and more transistors, and use more and more power. As CPUs use more power, the amount of heat that the CPU generates when operating rises. This heat has to be taken away from the computers, and so, computer centers have significant air conditioning installations simply to keep the computers contained within them cool. The failure of an air conditioning installation in a server room can be disastrous, since when CPUs get too hot (when the heat they generate is not extracted), they fail very rapidly.

As computers get faster and faster, and there are more and more computers within the same amount of space, the amount of power and infrastructure that is required to cool these computers is increasing very rapidly and, indeed, the importance of that cooling infrastructure is rising rapidly. Moreover, the time for a significant problem to arise should that cooling infrastructure fail is decreasing rapidly.

Blade systems go some way toward helping to alleviate cooling issues For example, sharing power supplies and cooling enables more efficient cooling for the blades contained within the chassis. However, there is still more computing power in a smaller space than the computer configuration blade systems, so the cooling problem is still quite significant.

Modern cooling systems, as befits their important role, are sophisticated systems. They are computerized, they can often be networked, and they can often be controlled remotely. These cooling systems have numerous sensors, all providing information to the cooling system concerning which areas of the computer center are too cold, which are too warm, and so forth.

Related to the above is the issue of power costs. The increased power consumption of computers entails the purchase of more electricity, and the associated increased power dissipation and cooling requirements of these computers entails the purchase of even more electricity. The power costs for computer centers are therefore large, and decidedly variable. In modern western electricity markets, the price of electrical power fluctuates (to a greater or lesser extent), and the computer center consumer, which has a large and relatively inflexible demand, is greatly exposed to these fluctuations. Infrastructures wherein the consumer is able to determine the spot price being charged for electricity at the point of consumption are becoming increasingly common, permitting the consumer the option of modifying demand for electricity (if possible) in response to the current price.

### SUMMARY OF THE INVENTION

It is therefore an object of the present invention to use techniques from the fields of autonomic and on demand computing in order to permit a computer center to be dynamically reprovisioned in order to satisfy ever changing heat dissipation and power consumption environments.

According to the invention, as best illustrated in an on demand computer center, some or all of the hosted applications running on the computers therein can be moved around (that is to say, relocated from one machine to another). Although the total heat dissipation and power consumption requirements for a computer center may remain the same over a long period of time (such as a 24 hour computing cycle), instantaneous power consumption and heat dissipation loads may be changed to more efficiently and effectively use the computer center resources and reduce peak loads. This may be accomplished by reprovisioning applications to computer center resources with lower power consumption and heat dissipation loads and/or rescheduling applications to time slots during which these loads are typically lower. Given that the heat dissipation requirements of the center are related, in some way, to the number of computers that are active, and how active they are, it can be seen that relocating applications will change the heat dissipation requirements of the computer center. At the same time, such a relocation will also change the power consumption of the computer center. In addition, some or all of the tasks that the computers in the on demand computer center must carry out can be rescheduled. That is to say, the times at which these tasks are to run can be changed. It can be seen that rescheduling applications will also change the heat dissipation (and power costs) of the computer center.

In this preferred embodiment, a controlling computer receives input data from the center's cooling system (this data includes data from the cooling system's sensors), from the center's power supply, from the computers within the center (this information could come from the computers themselves or from other controlling computers within the computer center), and temperature and power consumption information from the hardware sensors within the individual computers. The controlling computer is also aware (either explicitly or by dynamic position determination) of the relative locations of the computers within the computer center.

In addition to the above, the controlling computer is equipped with software implementing algorithms that predict how the cooling system will behave in certain circumstances, and how the power consumption of the computer center will change in those same circumstances. These algorithms also take into account the change in performance and functionality of the overall computer center that would result from the relocation of the various applications to other computers (such an understanding is inherent in autonomic and on demand systems).

The controlling computer is now able to evaluate its inputs and make changes (in the form of relocating and/or rescheduling applications) to the computer center's configuration. It can monitor the effects of those changes and use this information to improve its internal algorithms and models of the computer center.

In another preferred embodiment, the controlling computer is able to directly control the cooling system—specifically, it can change the level and location of the cooling provided to the computer center to the extent permitted by the cooling system. In this embodiment, the controlling computer directly controls the cooling system in an attempt to achieve the appropriate level of heat dissipation for each of the software configurations that it derives.

In yet another preferred embodiment, the controlling computer is a more subordinate part of the autonomic or on demand control system. It is not able to relocate applications directly, only to suggest to the supervisory control system that such applications be relocated and/or rescheduled. The supervisory control system, in this embodiment, can reject those suggested relocations for reasons that the controlling computer could not be expected to know about; e.g., the relocations and/or rescheduling would cause one or another of the applications in the computer center to fail or to miss its performance targets.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating a data center component of the type in which the present invention is implemented;

FIG. 2 is a block diagram illustrating a data center comprising a plurality of data center components implementing a preferred embodiment of the invention;

FIG. 3 is a block diagram illustrating various sensors used to expand upon the data center's cooling equipment;

FIG. 4 is a graph of a power consumption curve for a hypothetical server; and

FIG. 5 is a flow diagram which illustrates the operation of a preferred embodiment of the invention.

### DETAILED DESCRIPTION OF PREFERRED EMBODIMENTS OF THE INVENTION

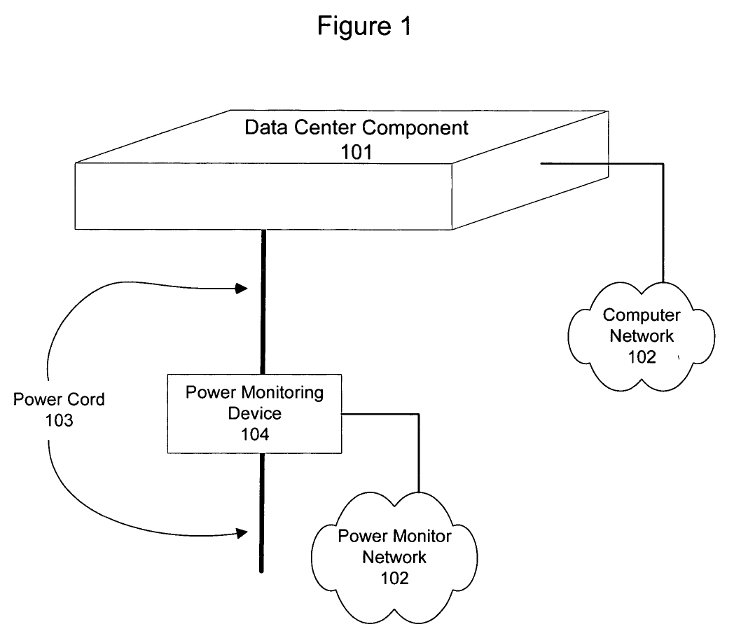

Referring now to the drawings, and more particularly to FIG. 1, there is shown a data center component 101, such as addressed by the present invention. This data center component 101 is, for purposes of this embodiment, an IBM eServer xSeries 335; however, any number of computers, equivalent as far as this invention is concerned, could be substituted here. This data center component 101 is connected to a computer network connectivity means 102. The computer network connectivity means 102 could be any appropriate networking technology, including Token Ring, ATM (Asynchronous Transfer Mode), Ethernet, and other such networks. Those skilled in the art will recognize that so-called “wireless networks” can also be substituted here. Also shown in FIG. 1 is an electrical power cord 103, supplying power to the data center component 101. In this embodiment, power cord 103 runs through a power monitoring device 104. This device monitors the amount of power that the data center component 101 is using at any given time. The power monitoring device 104 is connected to a reporting network 105, by which it is able to communicate the monitored power usage of the data center component 101.

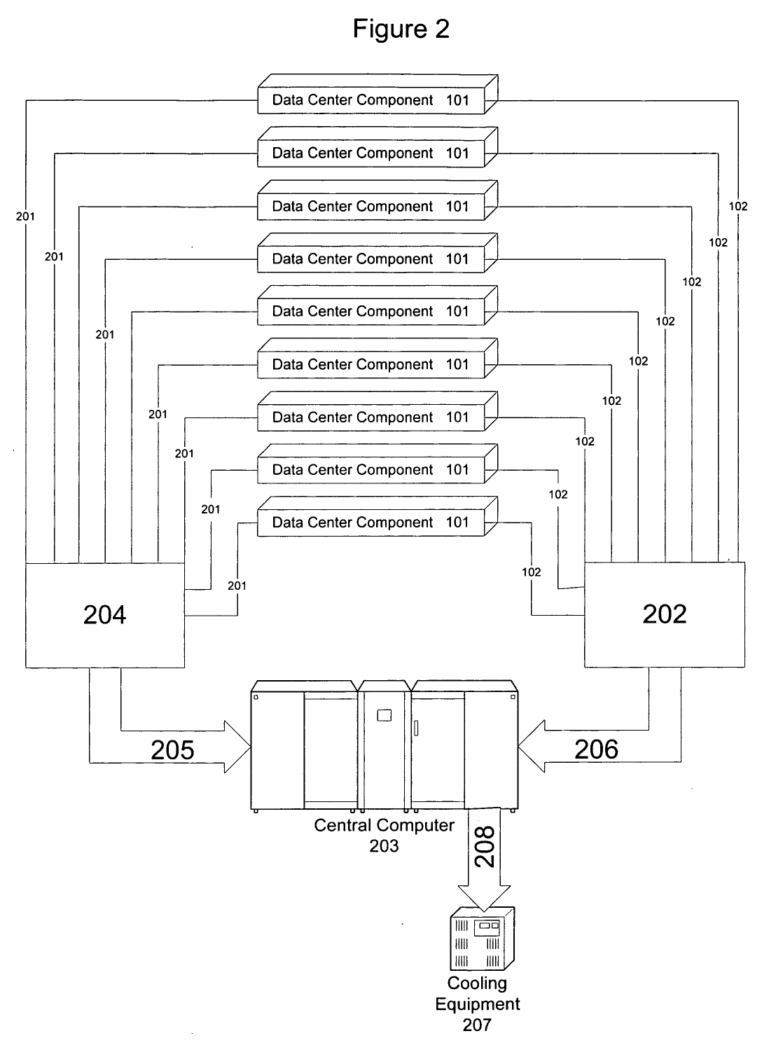

Turning now to FIG. 2, which represents a data center implementing a preferred embodiment of the invention, there is shown a plurality of instances of the data center component 101 first shown in FIG. 1. Also shown in FIG. 2 is the computer network connectivity means 102 from FIG. 1. In FIG. 2, the connections of each of the data center components 101 to the computer network connectivity means 102 lead into a network switching device 202. Those skilled in the art will recognize that a hub, router, firewall, or other network joining device would serve equally well in place of network switching device 202. FIG. 2 also shows the central control computer 203, which is also connected by a network connection 206 to the network switching device 202. Via network connection 206, the central control computer 203 is able to receive information from, and send commands to, the data center components 101.

FIG. 2 also illustrates the power connections and power reporting means 201 to the data center components 101. These power connections and power reporting means 201 incorporate power cord 103, power monitoring device 104, and power reporting network 105 from FIG. 1. For clarity, these component parts are omitted from FIG. 2. The power reporting network 105 component part of the power connection and power reporting means 201 connects to the power reporting network switching device 204 (the power reporting network 105 may be based upon the same technology as the computer network connectivity means 102, in which case the power reporting network switching device 204 may be the same type of device as the network switching device 202). Also connected to the power reporting network switching device 204, via connection 205, is central control computer 203. By means of this connection 205, the central computer 203 is able to monitor the power usage of the data center components 101.

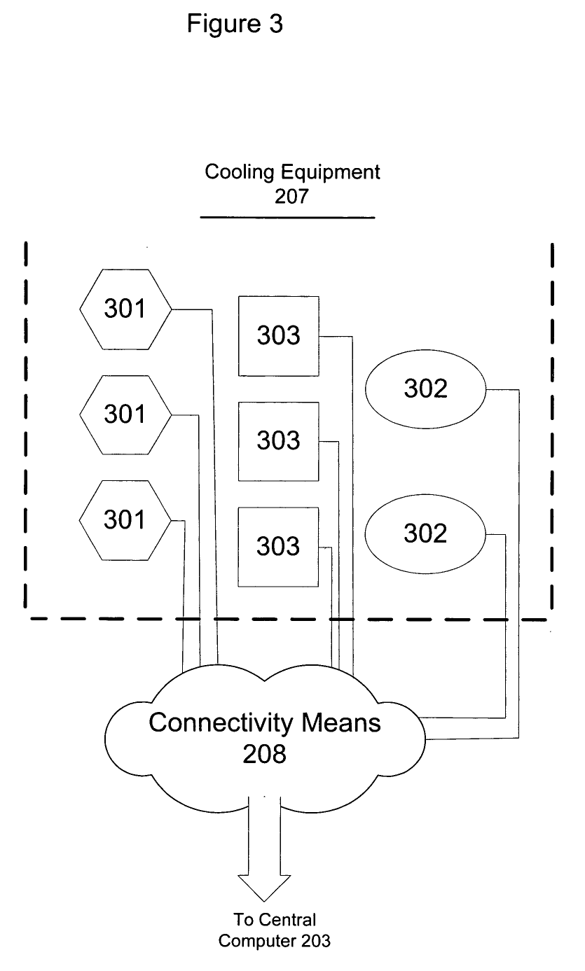

FIG. 2 also shows the connection 208 of the central computer 203 to the data center's cooling equipment 207. This connection 208 permits the central computer 203 to receive information from, and send commands to, the data center's cooling equipment 207. The data center's cooling equipment 207 is shown in more detail in FIG. 3, to which reference is now made.

FIG. 3 expands upon the data center's cooling equipment, introduced as 207 in FIG. 2. In this embodiment, the cooling equipment comprises a plurality of temperature sensors 301, a separate plurality of cooling devices 302, and a separate plurality of air flow sensors 303. All of these temperature sensors 301, cooling devices 302, and air flow sensors 303 are connected to connectivity means 304, the combination of which corresponds to connection 208 in FIG. 2.

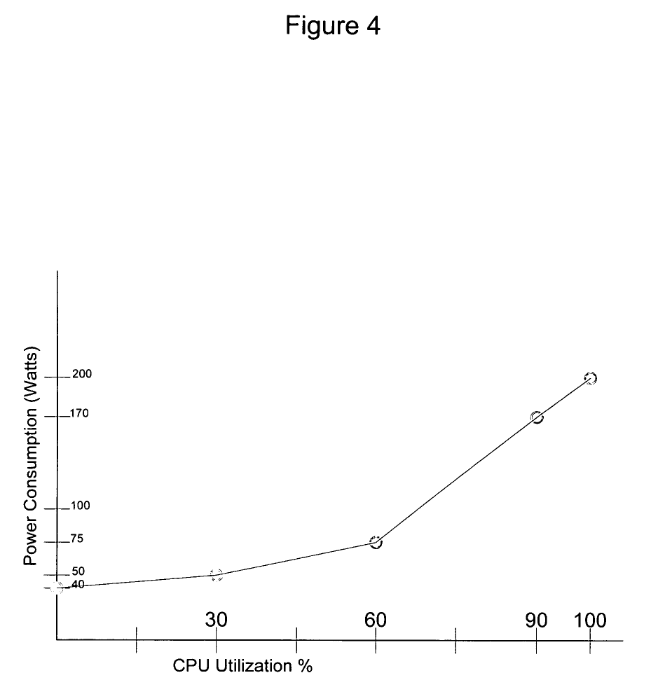

Turning now to FIG. 4, which illustrates a power consumption curve for a hypothetical server. This computer, when idle, consumes 40 Watts of electrical power. This particular computer uses more and more power for less and less benefit towards the top end of the curve—at 30% utilization, it uses 50 Watts (only 10 Watts more than at idle), but at 100% utilization it uses 200 Watts.

Those skilled in the art will recognize that the curve shown is idealized. The power consumption of real computers are more complex than that shown, and do not only depend on CPU utilization. However, this hypothetical curve is sufficient to illustrate the invention at hand.

A particular data center is comprised of ten identical computers, all of which have power consumption characteristics as shown in FIG. 4—that is to say, the ten computers are identical. This data center is only required to run ten instances of a single computational task. This computational task requires 30% of the CPU of the computers in the data center, and can use no more. It can easily be seen, therefore, that to obtain the maximum performance, no more than three instances of the computation task can be run per computer—three instances on a single computer will consume 90% of the CPU, and adding one more instance would cause performance to suffer as there would no longer be sufficient CPU to go around.

There are a variety of approaches, therefore, to determine where to install the tasks on the computers in the data center. A simple bin-packing approach would result in a decision to install three tasks each on three computers (for a total of nine tasks), and the single remaining task on a fourth computer. Thus, the first three computers would run at 90% CPU utilization, and the fourth would run at 30% CPU utilization. The power consumption of this configuration (Configuration A) is as follows:
(3×170)+(1×50)=620 Watts

An alternate configuration (configuration B) would be to install one task on each of the ten computers. All ten computers, in configuration B, would run at 30% CPU utilization, resulting in a power consumption of:
(10×50)=500 Watts

Examining the power curve shown in FIG. 4, however, it can be seen that a sensible configuration (configuration C) is one in which two tasks are installed on each of five computers, resulting in a power consumption of:
(5×75)=375 Watts

This is, in fact, the optimal power consumption configuration for the so-described system.

The discussion above assumes that computers that are not in use can be switched off, by the controlling computer. If this is not the case, and computers that are not running one or more tasks must remain on, but idle, the power consumption figures for the three configurations described change, as follows:
(3×170)+(1×50)+(6×40)=860 Watts Configuration A′
(10×50)=500 Watts Configuration B′ (remains the same)
(5×75)+(5×40)=575 Watts Configuration C′
In this variant, the controlling computer's optimal choice is configuration B′, because the incremental cost of running one task instance on a machine over running no instances on that same machine is so low (only 10 Watts).

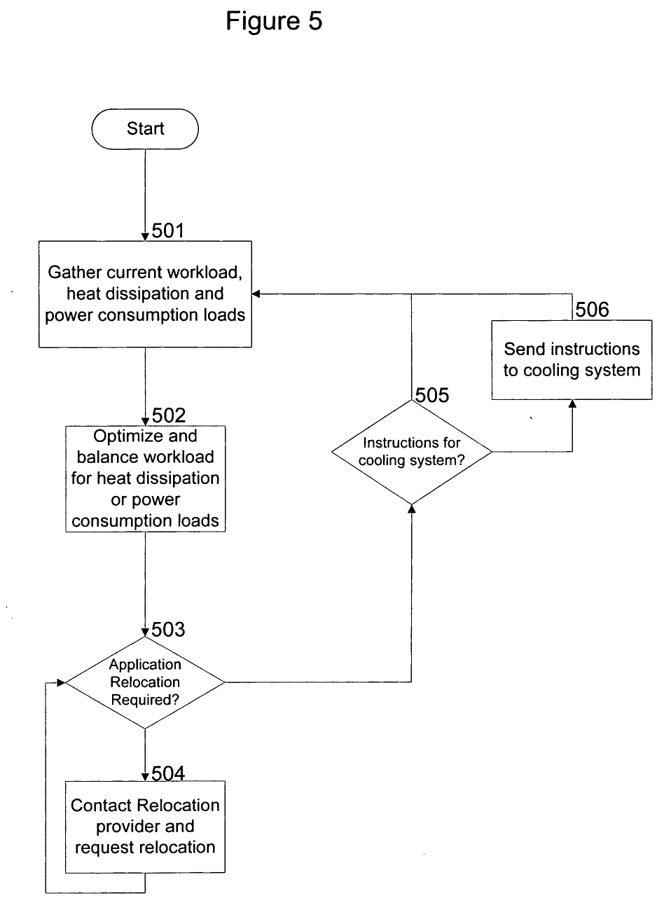

Turning now to FIG. 5, which illustrates the operation of a preferred embodiment of the current invention. FIG. 5 represents the control flow within the controlling computer. First, the controlling computer gathers 501 the characteristics of the current workload, heat load, and power load. This information is gathered via the communication means 205 and 206 shown in FIG. 2. Next, the controlling computer optimizes and balances 502 the so-determined work load for heat load and/or power load. Optimization can be achieved by a wide range of techniques are available and will be recognized by those skilled in the art.

Following the optimization step 502, the controlling computer has a list of application relocations that the optimization step recommended. In step 503, the controlling computer determines if there are any entries in this list. If so, the controlling computer contacts 504, the relocation controller, and requests that the application be so moved. It then returns to step 503 to process the next entry in the relocation list. When the list becomes empty, the controlling computer proceeds to step 505. If no instructions are required for the cooling system, the process returns to gathering workload, power, load, and heat load characteristics at step 501. In the event that adjustments are required within the cooling system, step 506 will send instructions to the cooling system.

Execution now passes back to the beginning of the controlling computer's operational flow at step 501.

While the invention has been described in terms of preferred embodiments, those skilled in the art will recognize that the invention can be practiced with modification within the spirit and scope of the appended claims.

What we claim is as follows:

1. A method for dynamically re-provisioning applications and other server resources in a computer center in response to power consumption and heat dissipation information, comprising the steps of:
monitoring at least one of power consumption or temperature of each of a plurality of data center components which comprise a computer center; and either
a) relocating one or more applications from one or more data center components to other data center components of the computer center as needed to change at least one of power consumption and heat dissipation loads within the computer center; or
b) rescheduling one or more applications running on one or more data center components of the computer center as needed to change at least one of power consumption and heat dissipation loads within the computer center.

2. The method of claim 1 wherein step a) is performed.

3. The method of claim 1 wherein step b) is formed.

4. The method of claim 1 further comprising the step of controlling cooling devices within the computer center as needed to change heat dissipation loads within the computer center.

5. The method of claim 1 wherein said relocating step changes both power consumption and heat dissipation loads within the computer center.

6. The method of claim 1 wherein said rescheduling step changes both power consumption and heat dissipation loads within the computer center.

7. A system for dynamically re-provisioning applications and other server resources in a computer center in response to power consumption and heat dissipation loads, comprising:
means for monitoring at least one of power and temperature of each of a plurality of data center components which comprise a computer center; and either
a) means for relocating one or more applications from one or more data center components to other data center components of the computer center as needed to change at least one of power consumption and heat dissipation loads within the computer center; or
b) means for rescheduling one or more applications running on one or more data center components of the computer center as needed to change at least one of power consumption and heat dissipation loads within the computer center.

8. A system for dynamically re-provisioning applications and other server resources in a computer center in response to power consumption and heat dissipation loads, comprising:
means for monitoring at least one of power consumption and temperature of each of a plurality of data center components which comprise a computer center;
means for relocating one or more applications from one or more data center components to other data center components of the computer center as needed to change at least one of power consumption and heat dissipation loads within the computer center; and
means for rescheduling one or more applications running on one or more data center components of the computer center as needed to change at least one of power consumption and heat dissipation loads within the computer center.
